(19) United States
(12) Patent Application Publication
(10) Pub. No.: US 2007/0208904 A1
(43) Pub. Date: Sep. 6, 2007

(54) Wear leveling method and apparatus for nonvolatile memory

(76) Inventors: Wu-Han Hsieh, Linkuo Township (TW); Yuan-Cheng Chen, Jhubei City (TW)

Correspondence Address: Poh C. Chua;PILLSBURY WINTHROP SHAW PITTMAN LLP, 1650 Tysons Boulevard, McLean, VA, 22102, US

(21) Appl. No.: 11/366,582

(22) Filed: Mar. 3, 2006

(51) Int. Cl. G06F 12/00

(52) U.S. Cl. 711/103

(57) ABSTRACT

A wear leveling apparatus uniformly distributes wear over a nonvolatile memory containing a plurality of memory blocks. The wear leveling apparatus includes a memory unit for storing a record of cold block candidates in the nonvolatile memory and a control unit configured to update the memory unit and release the cold block candidates under a threshold condition. The control unit selects a new memory block to replace one cold block candidate in the memory unit when the cold block candidate is matched with a written address in a write command for the nonvolatile memory. The cold block candidates remained in the memory unit are identified as cold blocks when the nonvolatile memory has been written more than a predetermined write count threshold. The memory blocks with infrequent erasure can be identified and released to uniformly distribute wear over the nonvolatile memory.

### BACKGROUND

1. Field of the Invention

The present invention relates generally to a method and apparatus for extending the life of a memory device and, more particularly, to a wear leveling method and apparatus for nonvolatile memory.

2. Background of the Invention

Nonvolatile memories such as flash memories do not require a power source to retain their memory content. Additionally, flash memories are generally compact size, and they have low power consumption because they do not contain moving parts. Accordingly, flash memories have been considered to be good replacements for conventional hard and floppy disk drives. As a result, flash memories are extensively used for consumer products, such as digital still cameras (DSCs), mobile phones and portable MP3 players.

One major limitation for flash memories is the inability to directly program flash memory cells. In a typical use, each flash memory cell that is stored with data is erased before new data is written thereto. Since flash memory is characterized in term of finite erase-write cycles, the flash memory has defective risk when some of its cells are erased beyond the finite cycles. The problem is more serious in a flash memory that stores system programs because such flash memory has even fewer chances to update or modify. Accordingly, there is a need to extend the useful life of the flash memory by wear leveling, wherein erasure of the cells is uniformly distributed to all cells.

U.S. Pat. No. 6,000,006 discloses a unified re-map method for wear-leveling of non-volatile flash random access memory (RAM) mass storage. A unified re-map table in a RAM is used to arbitrarily re-map all logical addresses from a host system to physical addresses of flash-memory devices. Each entry in the unified re-map table contains a physical block address (PBA) of the flash memory allocated to the logical address. Two write count values are stored with the PBA in the table entry. A total-write count indicates a total number of writes to the flash block since manufacture. An incremental-write count indicates the number of writes since the last wear-leveling operation that moved the block. Wear-leveling is performed on a block being written when both total and incremental counts exceed system-wide total and incremental thresholds. However, the wear-leveling method disclosed in this patent does not account for static area in the flash memory. The static areas are physical locations on flash memory that contain data of nearly no change. The data, for example, could be operation system code or application program. Moreover, the provision of the re-map table for all flash memory cells is a considerable overhead cost for the flash memory.

U.S. Pat. No. 6,732,221 discloses a wear leveling method of static areas in flash memory. This patent teaches that the wear leveling operation is activated one time for a certain number of write or erase operations. After the wear leveling operation is activated, a memory cell in the flash memory is selected, independently of how often the memory cell has been erased, to move the data thereof to a free cell. The memory cell is selected in a manner that successive selections will ultimately select all units. This wear leveling method provides an opportunity to modify accessing pattern for the static area. However, this wear leveling method does not provide any criterion for selecting memory cell and unwanted erasure may be performed to the frequently erased units.

### SUMMARY OF THE INVENTION

The present invention provides a wear leveling method and apparatus for nonvolatile memory. In the preferred embodiment of the invention, the wear on the nonvolatile memory is leveled with high efficiency. Furthermore, the method provides the ability to change the accessing pattern of static area of the nonvolatile memory.

A preferred embodiment of the invention is method for leveling wear associated with a nonvolatile memory that contains a plurality of memory blocks. First, a record of at least one cold block candidate for the nonvolatile memory is maintained. Second, content in the cold block candidate is moved to at least one free block of the memory blocks when a threshold condition occurs. For example, the threshold condition can occur when the nonvolatile memory is operated for a predetermined time period. Preferably, the first step of maintaining the record of at least one cold block candidate further involves initializing the record by selecting at least one memory block of the plurality of memory blocks stored with data from the nonvolatile memory. Preferably, the method includes an additional step of providing a write count for counting a write command number of the nonvolatile memory. The threshold condition occurs when the write count exceeds a predetermined write count threshold. The method may include the step of resetting the write count after moving the content in the cold block candidate. In another embodiment, the method may include the step of updating the record when a written address for the nonvolatile memory is matched with one cold block candidate in the record. The method may further include the step of replacing the matched cold block candidate in the record with a new memory block stored with data in the nonvolatile memory. The new memory block is preferably one that is related to the cold block candidate in a predetermined order. For example, the new memory block is one that is next to the cold block candidate in a descending order. Alternatively, the new memory block is ahead of the cold block candidate in an ascending order. In another variation, the method further includes the step of reinitializing the record by selecting at least one new cold block candidate after moving the content in the cold block candidate.

Another embodiment of the invention provides a method for identifying infrequently-erased block in a nonvolatile memory that includes a plurality of memory blocks and characterized with finite erase cycles. The method includes the steps of selecting at least one memory block stored with data as a candidate of infrequently-erased block in the nonvolatile memory; replacing the candidate with a new memory block when a written address in a write command for the nonvolatile memory is matched with the candidate; and identifying the candidate as infrequently-erased block when a threshold condition occurs. The threshold condition may occur, e.g., when the nonvolatile memory is operated for a predetermined time period. Preferably, the method further includes the step of providing a probe index designated to a memory block stored with data and related to the candidate in a predetermined order. The new memory block may be selected from a memory block designated by the probe index. Preferably, the method may further include the step of providing a write count to account for a writing operation number to the nonvolatile memory and the write count is increased by one for each writing operation. In this implementation, the threshold condition occurs when the write count exceeds a predetermined write count threshold.

Another embodiment of the invention is a wear leveling apparatus for a nonvolatile memory containing a plurality of memory blocks. The wear leveling apparatus includes a memory unit for storing cold block candidates in a flash memory; and a control unit configured to select a new memory block to replace one of the cold block candidates with a writing command associated with the cold block candidate and configured to move the content of the cold block candidates to free blocks in the nonvolatile memory in a threshold condition. Preferably, the memory unit includes one or more of a candidate storage to store a physical block addresses of the cold blocks candidates, a write counter to account for a number of write operation to the nonvolatile memory, and a probe index to indicate a memory block stored with data and closest to the cold block candidates in a descending order.

### BRIEF DESCRIPTION OF THE DRAWINGS

FIG. 1 shows a block diagram of the wear leveling apparatus according to a preferred embodiment of the present invention.

FIG. 2 shows a flowchart of the wear leveling method according to a preferred embodiment of the present invention.

FIG. 3 shows a flowchart of the wear leveling method according to another preferred embodiment of the present invention.

FIGS. 4A to 4E show exemplary operations according to a wear leveling method of the present invention.

FIG. 5 shows a statistic model for a flash memory without wear leveling mechanism.

FIG. 6 shows a simulation result for evaluating the influence of window size on a flash memory implemented with the wear leveling method according to a preferred embodiment of the present invention.

FIG. 7 shows a simulation result for evaluating the influence of write count threshold on a flash memory implemented with the wear leveling method according to a preferred embodiment of the present invention.

FIG. 8 shows the comparison of wear statistics for an ordinary flash memory without wear leveling mechanism and a flash memory implemented with the wear leveling method according to a preferred embodiment of the present invention.

### DETAILED DESCRIPTION OF THE INVENTION

Generally, the present invention relates to wear leveling methods for nonvolatile memories. In the preferred embodiment of the invention, at least one hot block of a memory is selected as a cold block candidate, which is an infrequently-erased block. The physical block address of the candidate is recorded in a memory unit and is compared with the written address in each write command for accessing the nonvolatile memory. The record is updated by replacing the written address in the memory unit with the physical block address of a new hot block when the above-mentioned comparison is matched. The content of the cold block candidate is moved to one or more free blocks of the nonvolatile memory when the nonvolatile memory has been written more than a write count threshold. The write count threshold can vary per design.

Moreover, the present invention provides a wear leveling apparatus for a nonvolatile memory containing a plurality of memory blocks. The preferred wear leveling device of the invention includes a memory unit and a control unit. The memory unit stores cold block candidates in the flash memory. The control unit is configured to update the memory unit and release the cold block candidates under a threshold condition. More particularly, the control unit selects a new memory block to replace one cold block candidate in the memory unit when the cold block candidate is matched with a written address in a write command for the nonvolatile memory. The control unit moves the content of the cold block candidates to free blocks in the nonvolatile memory when the nonvolatile memory has been written more than a predetermined write count threshold. In this manner, the memory blocks with infrequent erasure can be released to level the wear on the nonvolatile memory. Alternatively, the control unit moves the content of the cold block candidates to free blocks in the nonvolatile memory according to another criterion. For example, the criterion can be when the nonvolatile memory has been operated more than a predetermined time period, such as about 10 minutes.

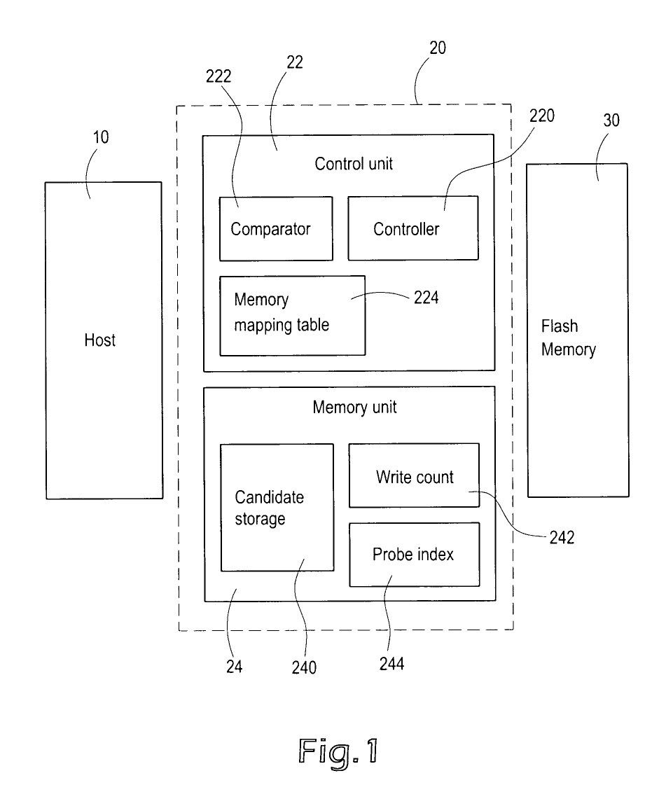

FIG. 1 shows a block diagram of the wear leveling apparatus according to a preferred embodiment of the present invention. Wear leveling apparatus 20 is used to uniformly distribute erasure over nonvolatile memory 30. The wear leveling apparatus 20 is bridged between a host 10 and the nonvolatile memory 30. As indicated in FIG. 1, flash memory 30 is an exemplary nonvolatile memory 30. It should be noted that the wear leveling apparatus 20 according to the present invention can be applied to other kinds of nonvolatile memories as well. For example, the present invention can be implemented in erasable programmable read-only memory (EPROM), electrically erasable programmable read-only memory (EEPROM), and the like. The flash memory 30 includes a plurality of memory blocks. A memory block is a basic element for erasing operation. The host 10 can issue a reading command to read data from the flash memory 30. Similarly, the host 10 can also issue a writing command to write data to the flash memory 30 with a written address designated by the writing command. The written address is analyzed by the wear leveling apparatus 20 to uniformly distribute wear over the flash memory 30. In this manner, the invention prolongs the life of the flash memory 30 by delaying the onset of failure for the flash memory 30.

As shown in FIG. 1, the wear leveling apparatus 20 includes a control unit 22 and memory unit 24. The control unit 22 is used for processing the written address in the writing command. The memory unit 24 is used for storing a record about cold block candidates in the flash memory 30. The term “cold block” refers to a memory block with relatively infrequent erasure. Criteria for identifying the cold block are detailed below. The control unit 22 includes a controller 220, a comparator 222, and a memory mapping table 224. The controller 220 executes a wear leveling algorithm. The memory unit 24 includes a candidate storage 240, a write counter 242, and a probe index 244. The candidate storage 240 stores the physical block addresses of the cold block candidates in the flash memory 30.

In an exemplary implementation of the invention, when the host 10 intends to write specific memory blocks in the flash memory 30, the host 10 sends a writing command with a logical block address associated with the specific memory blocks. The controller 220 of the control unit 22 converts the logical block address into a physical block address with reference to the memory mapping table 224. Hereinafter, the physical block address that is converted by the memory mapping table 224 is also be referred to as “written address.” The written address is compared with the physical block address of each cold block candidate in the candidate storage 240. When the written address matches with one cold block candidate stored in the candidate storage 240, the physical block address of the cold block candidate that is matched with the written address is removed from the candidate storage 240. Then, a new cold block candidate is selected from a memory block stored with data in the flash memory 30 and the physical block address of the new cold block candidate is stored in the candidate storage 240. Hereinafter, the memory block stored with data in the flash memory 30 is also referred to as “hot block.”

Memory blocks are identified as cold block candidates under certain criteria. For example, memory blocks that remain in the candidate storage 240 can be identified as cold blocks based on a predetermined write count threshold. In particular, when the number of writing operations associated with certain memory blocks exceeds a predetermined write count threshold, those memory blocks are identified as cold block. Then, content stored in the identified cold blocks is moved to free the blocks in the flash memory 30. Afterward, new cold block candidates are selected from hot blocks in the flash memory 30 and the physical block addresses of the new cold block candidates are stored in the candidate storage 240. The window size for the candidate storage 240, and the predetermined write count threshold can be varied according to design choice. The predetermined write count threshold can be from 10 to hundreds of write counts. The predetermined write count threshold can be determined with reference to many factors, such as but not limited to, the ratio of hot data to cold data, and the update frequency of hot data, etc. Alternatively, a straight forward way to estimate the write count threshold is to simulate the real product behavior. In this application, a simulation result with the threshold of 10 write count is demonstrated and the simulation result shows an acceptable performance.

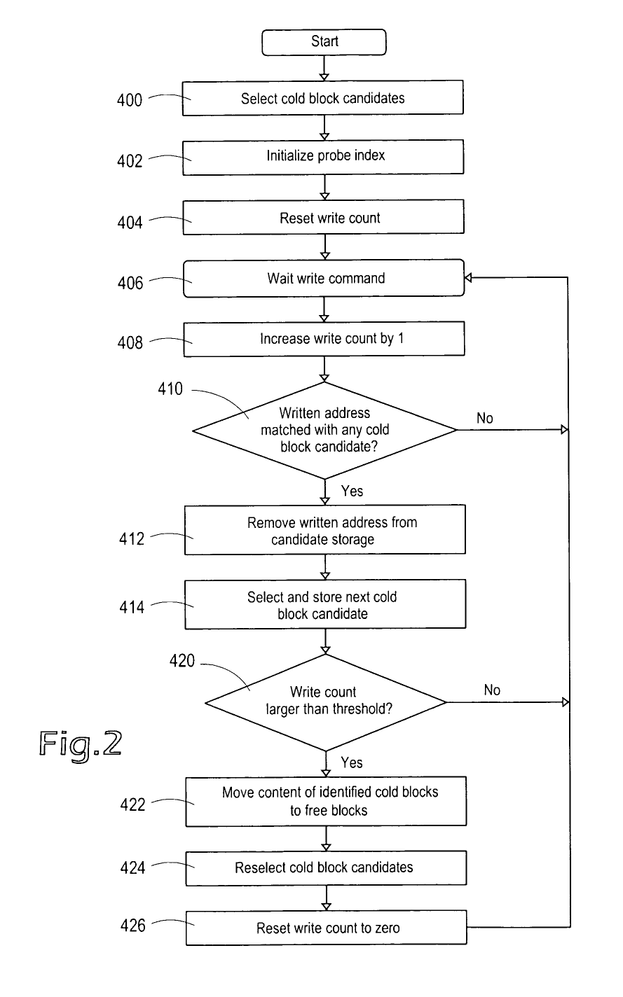

FIG. 2 is a flowchart showing an exemplary operation of the wear leveling apparatus 20. Steps 400 to 404 are initialization steps performed by the controller 220 to prepare the flash memory 30 to be accessed by the host 20. In step 400, at least one hot block of the flash memory 30 is selected as a cold block candidate. The physical block address of the cold block candidate is stored in the candidate storage 240. Afterward, in step 402, a probe index 244 is initialized to designate a specific physical block address in the flash memory 30. For example, the specific physical block address can be a physical block address of a hot block, which is closest to the cold block candidate in descending order. Then, in step 404, a writing count stored in the write counter 242 is reset to zero. The specific physical block address can also be a physical block address of a hot block, which is closest to the cold block candidate in ascending order.

The controller 220 then waits for write command sent from the host 10 in step 406. If a write command is sent from the host 10 for accessing the flash memory 30, the writing count stored in the write counter 242 is increased by one in step 408. Then, in step 410, a written address in the writing command is compared with the physical block address of the cold block candidates stored in the candidate storage 240. The wear-leveling process returns to step 406 when the written address is not matched with the physical block address of any cold block candidate stored in the candidate storage 240. Otherwise, steps 412 to 414 are performed when the written address is matched with the physical block address of one cold block candidate stored in the candidate storage 240.

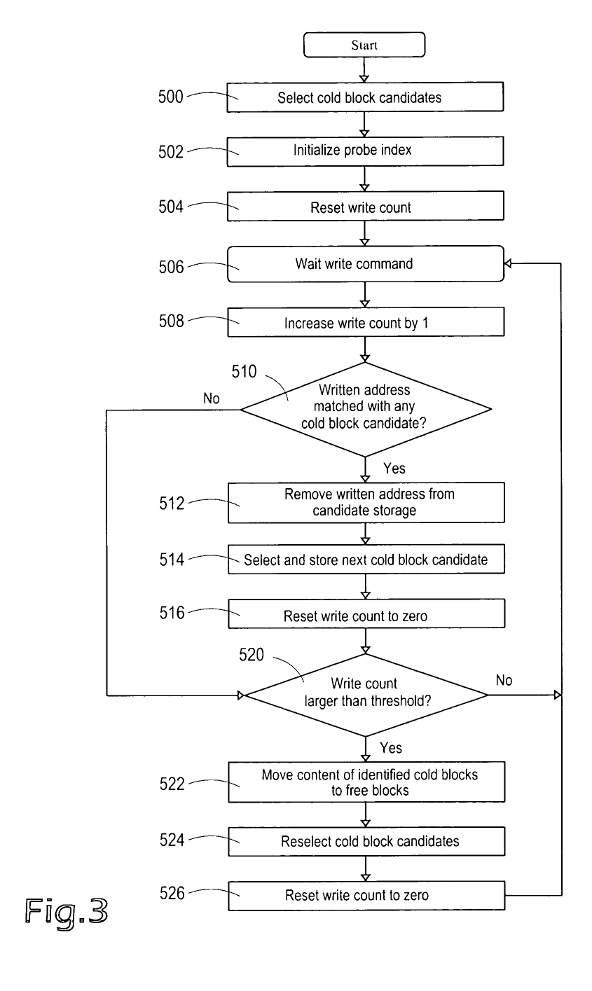

In step 412, the physical block address matched with the written address is removed from the candidate storage 240. In step 414, a new cold block candidate is selected and stored in the candidate storage 240. More particularly, the new cold block candidate is a hot block designated by the probe index 244. Afterward, the probe index 244 is designated to next hot block after the new cold block candidate is stored. A hot block is a memory block that is stored with data. One advantage of the present invention is to make all memory blocks become hot blocks and to evenly spread the wear among all the hot blocks. Accordingly, contents of qualified cold blocks are moved to free blocks such that the free blocks can become “hot blocks”. The exemplary process shown in FIGS. 2 and 3 continues to identify and release cold blocks until the flash memory is finally worn out. The probe index is preferably pointed to next hot block for the ease of programming. However, the probing strategy may be sequential, random, or other specific orders. The probing strategies can be tailored for specific product. Therefore, the above-mentioned sequential probing strategy is for illustration and does not impose limitation on the scope of the present invention.

Step 420 then examines whether the writing count stored in the write counter 242 is larger than a predetermined write count threshold. The wear-leveling process returns to step 406 when the writing count is not larger than the predetermined write count threshold. Otherwise, steps 422 to 426 are performed when the writing count is larger than the predetermined write count threshold.

In step 422, the cold block candidate in the candidate storage 240 is identified as cold block and the content of the identified cold block is moved to free block in the flash memory 30. In step 424, at least one new cold block candidate is selected with reference to the probe index 244 and the physical block address of the new cold block candidate is stored in the candidate storage 240. In step 426, the write count in the write counter 242 is reset to zero and the wear-leveling procedure is back to step 406 to wait for another write command.

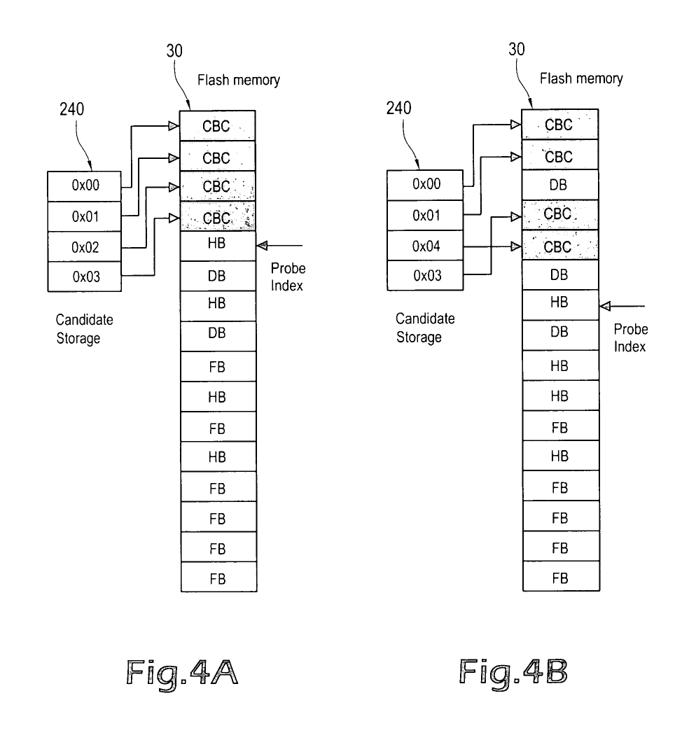

FIGS. 4A to 4E provide exemplary operations of a preferred embodiment of the wear leveling method of the present invention. In FIGS. 4A to 4E, memory blocks of the flash memory 30 that are marked with “CBC” are cold block candidates.

Memory blocks that are labeled with “FB” represent free blocks. Memory blocks that are labeled with “DB” represent dirty blocks. Memory blocks that are labeled with “HB” represent hot blocks.

As shown in FIG. 4A, the window size for the candidate storage 240 is four.

The first four hot blocks in the flash memory 30 are selected as cold block candidates in the initialization step. The physical block addresses for the first four hot blocks, namely, 0x00, 0x01, 0x02, 0x03 are stored in the candidate storage 240 and the probe index 244 is designated to a hot block with physical block address 0x04, which is closest to the last one of the cold block candidates in descending order.

With reference to FIG. 4B, if a written address in a writing command sent from the host 10 is matched with the physical block address 0x02 present in the candidate storage 240, the record of the physical block address 0x02 is replaced by the physical block address 0x04 designated by the probe index. Moreover, the probe index is designated to a hot block with physical block address 0x06 closest to the last one of the cold block candidate in descending order.

Similarly, with reference to FIG. 4C, if a written address in another write command sent from the host 10 is matched with the physical block address 0x03 present in the candidate storage 240, the record of the physical address 0x03 is replaced by the physical block address 0x06 designated by the probe index.

Moreover, the probe index is designated to a hot block with physical block address 0x08 closest to the last one of the cold block candidates in descending order.

With reference to FIG. 4D, after a predetermined number of write operations, the physical block addressed remained in the candidate storage 240 are identified as cold blocks, which are infrequently erased memory blocks. The content stored in the identified cold blocks is moved to the free blocks. The identified cold blocks become dirty blocks and can be re-accessed after a “garbage collecting procedure.” The garbage collecting procedure is well known in this art and is not described in detail here.

Afterward, as shown in FIG. 4E, new cold block candidates are selected through the help of the probe index, and the physical block addresses 0x08, 0x09, 0x0A, 0x0B associated with the new cold block candidates are stored in the candidate storage 240.

In above description, the first four hot blocks in the flash memory 30 are selected as cold block candidates in sequential order. However, the cold block candidates can also be selected in random order. Moreover, the operation of moving the content of the identified cold blocks to the free blocks can be executed in background. User will not notice delay in the flash memory 30 due to the moving operation. Moreover, an erasure count field can be provided in the reserved area of each memory block of the flash memory 30 and the erasure count field records the number of erasure operations for each memory block. The cold block candidate will not be identified as cold block if the number of erasure operations for the cold block candidate is not less than a threshold value.

FIG. 3 shows a flowchart of the wear leveling method according to another preferred embodiment of the present invention. The steps shown in FIG. 3 are generally similar to those shown in FIG. 2. However, in step 510 if the written address is not matched with the physical block address of any cold block candidate in the candidate storage 240, the wear leveling process of this embodiment goes to step 520. Moreover, if the written address is matched with the physical block address of one cold block candidate in the candidate storage 240 in step 510, the write count is reset to zero in step 516 after the candidate storage 240 is updated with new cold block candidate. In this preferred embodiment, the wear leveling method can account for the accessing pattern where the comparison is not matched for many write operations.

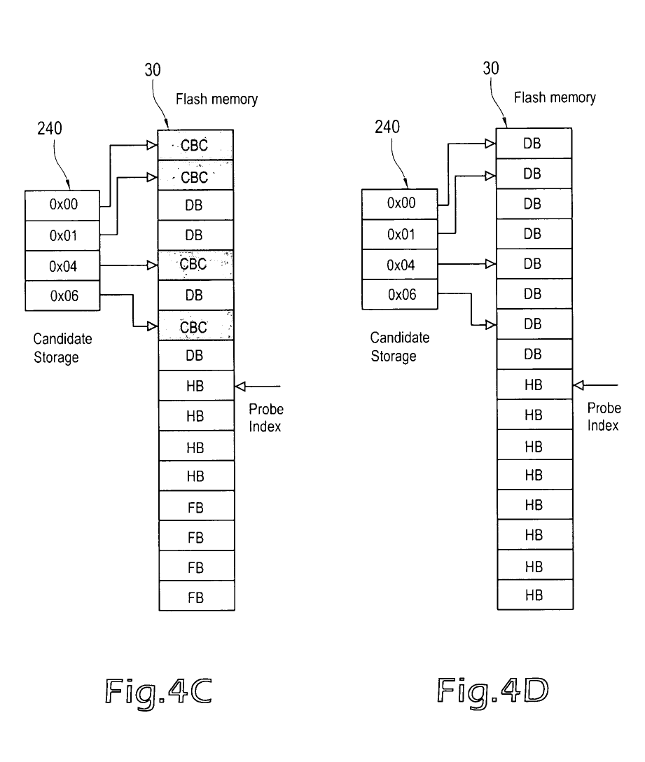

FIG. 5 shows a simulation model for performing 10,000,000 trial writing operations to a flash memory with 4096 blocks. The abscissa indicates the logical block address (LBA); the ordinate indicates the total written count that the relative LBA attempted to be written. As shown in FIG. 5, the written count distribution is roughly a normal distribution and uneven wear distribution can be easily observed.

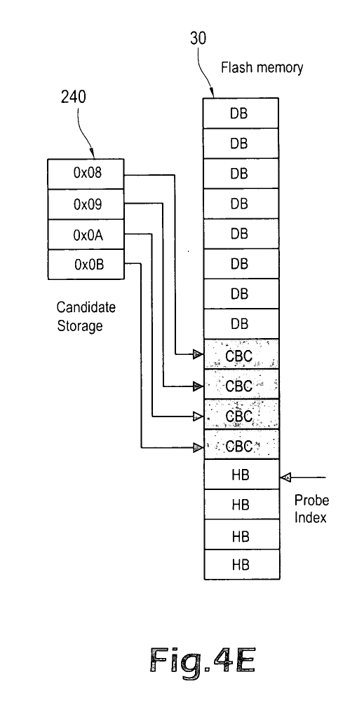

FIG. 6 shows a simulation result for evaluating the impact of window size on a flash memory implemented with the wear leveling method according to the present invention, in which the abscissa indicates window size (the block number in the candidate storage) and the ordinate indicates the standard deviation for the written count distribution. In this simulation, the threshold write count is 10,000 times. As can be seen from this figure, the standard deviation for the written count distribution is decreased and the wear is more uniform over the flash memory as the window size is increased.

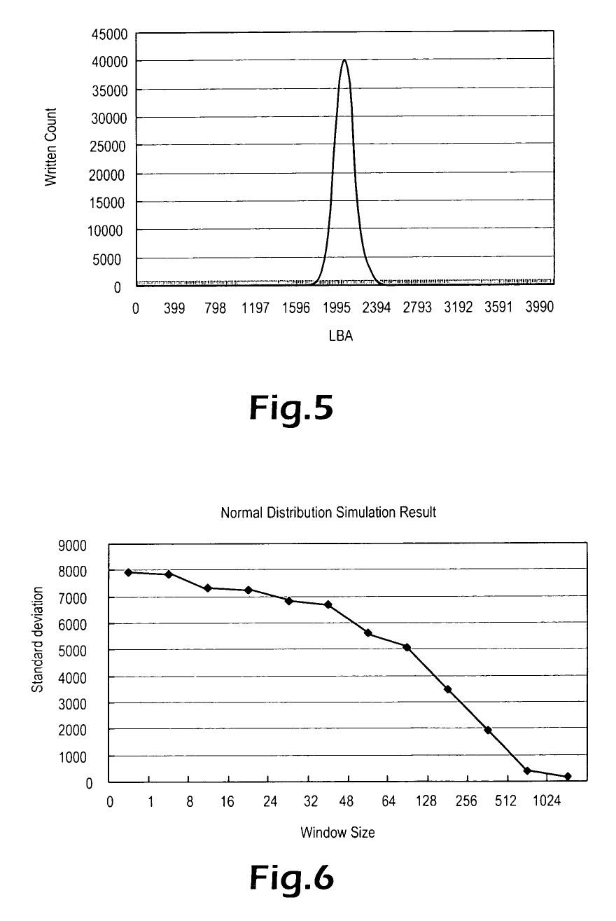

FIG. 7 shows a simulation result for evaluating the impact of write count threshold on a flash memory implemented with the wear leveling method according to the present invention, in which the abscissa indicates write count threshold and the ordinate indicates the standard deviation for the written count distribution. In this simulation, the window size is 1 block. As can be seen from this figure, the standard deviation for the written count distribution is decreased and the wear is more uniform over the flash memory as the write count threshold is decreased, namely, the wear leveling being performed more frequently.

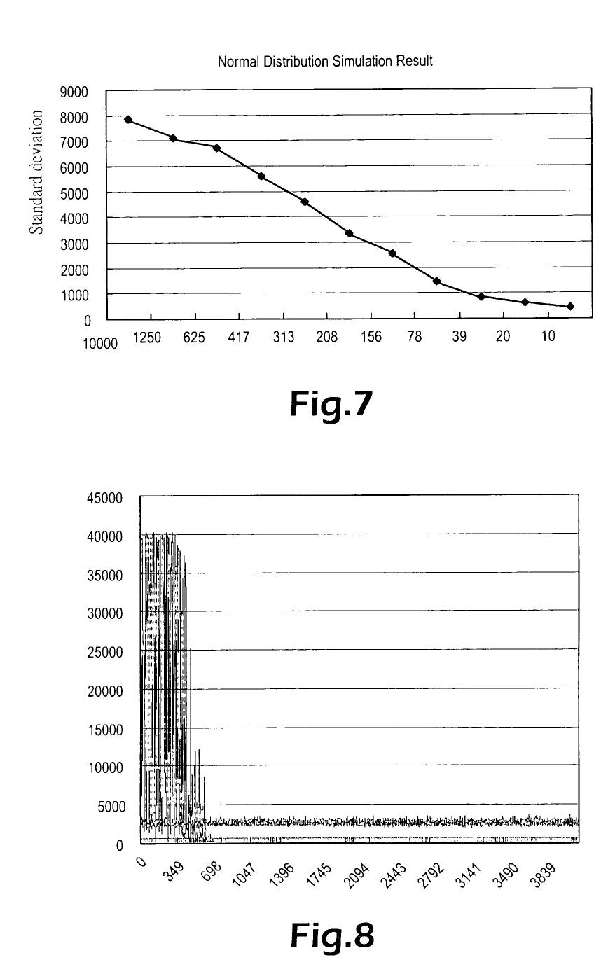

FIG. 8 shows the comparison of wear statistics for an ordinary flash memory without wear leveling mechanism and a flash memory implemented with the wear leveling method according to the present invention. In both flash memories, the memory block numbers are 4096, and 10,000,000 trial writing operations are conducted through simulation. The denser curve shown on the left part of the figure represents the wear statistics for the ordinary flash memory without wear leveling mechanism. The wears are concentrated on part of the memory blocks and the flash memory is defective after 24,949,984 trial writing operations according to simulation result. The smooth curve near the bottom of this figure represents the wear statistics for the flash memory implemented with the wear leveling method according to the present invention. In this example, the window size is 1 block and the write count threshold is 10 times. As can be seen from this figure, the wears are uniformly distributed for all cells. The flash memory is defective after 387,881,253 trial writing operations according to simulation result, which represents roughly 15 times improvement over the flash memory without wear leveling mechanism.

Thus, the wear leveling method and apparatus for nonvolatile memory uses memory unit for storing the addresses of cold block candidates. The wear leveling can be performed with less memory overhead and higher efficiency.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A wear leveling method for a nonvolatile memory containing a plurality of memory blocks, the method comprising:
maintaining a record of at least one cold block candidate for the nonvolatile memory; and
moving content in the at least one cold block candidate to at least one free block of the plurality of memory blocks when a threshold condition occurs.

2. The method of claim 1, wherein maintaining the record of at least one cold block candidate further comprises:
initializing the record by selecting at least one memory block of the plurality of memory blocks stored with data from the nonvolatile memory.

3. The method of claim 1, further comprising:
providing a write count for counting a write command number of the nonvolatile memory.

4. The method of claim 3, wherein the threshold condition occurs when the write Count exceeds a predetermined write count threshold.

5. The method of claim 1, wherein the threshold condition occurs when the nonvolatile memory is operated for a predetermined time period.

6. The method of claim 1, further comprising:
updating the record when a written address for the nonvolatile memory is matched with one cold block candidate in the record.

7. The method of claim 6, further comprising:
replacing the matched cold block candidate in the record with a new memory block stored with data in the nonvolatile memory.

8. The method of claim 7, wherein the new memory block is related to the cold block candidate in a predetermined order.

9. The method of claim 8, wherein the new memory block is next to the cold block candidate in a descending order.

10. The method of claim 8, wherein the new memory block is ahead of the cold block candidate in an ascending order.

11. The method of claim 1, further comprising:
reinitializing the record by selecting at least one new cold block candidate after moving the content in the cold block candidate.

12. The method of claim 3, further comprising:
resetting the write count after moving the content in the cold block candidate.

13. In a nonvolatile memory comprising a plurality of memory blocks and characterized with finite erase cycles, a method for identifying infrequently-erased block in the nonvolatile memory comprising:
selecting at least one memory block stored with data as a candidate of infrequently-erased block in the nonvolatile memory;
replacing the candidate with a new memory block when a written address in a write command for the nonvolatile memory is matched with the candidate; and
identifying the candidate as infrequently-erased block when a threshold condition occurs.

14. The method of claim 13, further comprising:
providing a probe index designated to a memory block stored with data and related to the candidate in a predetermined order.

15. The method of claim 14, wherein the new memory block is selected from a memory block designated by the probe index.

16. The method of claim 13, further comprising the step of providing a write count to account for a writing operation number to the nonvolatile memory and the write count is increased by one for each writing operation.

17. The method of claim 16, wherein the threshold condition occurs when the write count exceeds a predetermined write count threshold.

18. The method of claim 13, wherein the threshold condition occurs when the nonvolatile memory is operated for a predetermined time period.

19. A wear leveling apparatus for a nonvolatile memory containing a plurality of memory blocks, the wear leveling apparatus comprising:
a memory unit for storing cold block candidates in a flash memory; and
a control unit configured to select a new memory block to replace one of the cold block candidates with a writing command associated with the cold block candidate and configured to move the content of the cold block candidates to free blocks in the nonvolatile memory in a threshold condition.

20. The apparatus of claim 19, wherein the memory unit comprises a candidate storage to store a physical block addresses of the cold blocks candidates.

21. The apparatus of claim 19, wherein the memory unit comprises a write counter to account for a number of write operation to the nonvolatile memory.

22. The apparatus of claim 19, wherein the memory unit comprises a probe index to indicate a memory block stored with data and closest to the cold block candidates in a descending order.

23. The apparatus of claim 21, wherein the threshold condition is when the nonvolatile memory has been written more than a predetermined write count.

24. The apparatus of claim 23, wherein the control unit comprises a comparator to compare a count result of the write counter with the predetermined write count.

25. The apparatus of claim 19, wherein the control unit is configured to move the content of the candidates to the free blocks in background.
